(19) United States
(12) Patent Application Publication
(10) Pub. No.: US 2007/0287481 A1
(43) Pub. Date: Dec. 13, 2007

(54) APPARATUS AND METHOD FOR RETRIEVING A MULTIMEDIA MESSAGE IN A MOBILE COMMUNICATION TERMINAL

(75) Inventor: Youn-Taek OH, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/761,820

(22) Filed: Jun. 12, 2007

(30) Foreign Application Priority Data
Jun. 13, 2006 (KR) 2006-0052834

(51) Int. Cl. H04Q 7/20

(52) U.S. Cl. 455/466

(57) ABSTRACT

Provided are an apparatus and a method for retrieving multimedia messages in a mobile communication terminal. The method determines whether the Subscriber Identification Module (SIM) installed in the mobile communication terminal is altered when a retrieval event for a multimedia message occurs, and notifies a user that the user is not authorized to receive the multimedia message when the SIM is altered.

### PRIORITY

This application claims priority under 35 U.S.C. § 119 to an application filed in the Korean Intellectual Property Office on Jun. 13, 2006 and assigned Serial No. 2006-52834, the contents of which are incorporated herein by reference.

### BACKGROUND OF THE INVENTION

1. Field of the Invention

The present invention relates generally to an apparatus and method for retrieving multimedia messages in a mobile communication terminal, and in particular, to an apparatus and method for preventing the retrieval of multimedia messages in a mobile communication terminal when a subscriber identification module is altered following receipt of a notification message for a multimedia message.

2. Description of the Related Art

Multimedia Message Service (MMS) is a message service accommodating high-quality multimedia objects other than text. An MMS sends a MMS notification message informing a recipient of the arrival of a message before sending the corresponding message to the target terminal. This is performed differently from Short Message Service (SMS).

FIG. 1 is ladder type diagram illustrating a process of receiving a multimedia message with a mobile communication terminal according to the conventional art.

Referring to FIG. 1, in step 110, a transmission terminal 100 sends an M-Send.req including a multimedia message to a transmission MMS proxy-relay server 102. In step 112, the transmission MMS proxy-relay server 102 sends a response message, M-send.conf to the transmission terminal 100 and the multimedia message to a Target MMS proxy-relay server 104. Thereafter, in step 114, the Target MMS proxy-relay server 104 sends an MMS notification message, M-Notification.ind to a target terminal (Target MMS client) 106 to inform Target MMS client 106 of an arrival of the multimedia message.

Next, in step 116, the target terminal 106 sends an M-NotifyResp.ind to the Target MMS proxy-relay server 104, and displays the MMS notification message on the display unit for allowing a user to determine whether to receive the multimedia message. When the user agrees to receive the multimedia message, the target terminal 106 sends a WSP/HTTP GET.req to require the Target MMS proxy-relay server 104 to search and send the corresponding message in step 118.

Then, in step 120, the Target MMS proxy-relay server 104 sends the MMS message through an M-retrieve.conf to the target terminal 106, from responds to the Target MMS proxy-relay server 104 by sending an M-Acknowedge.ind in step 122. Thereafter, the Target MMS proxy-relay server 104, in step 124, responds to the transmission MMS proxy-relay server 102 that will deliver the response to the transmission terminal 100 in step 126.

As described above, after a reception of the MMS notification message, only the user decides whether to retrieve the multimedia message in the mobile communication terminal according to the conventional art. Thus, the user can perform retrieval even though the subscriber identification module is altered. As a result, the mobile communication terminal may connect with the network for retrieving multimedia messages inaccessible to the altered subscriber identification module, generating needless network overhead.

### SUMMARY OF THE INVENTION

An aspect of the present invention is substantially to solve at least the above problems and/or disadvantages and to provide at least the advantages described below. Accordingly, an aspect of the present invention is to provide an apparatus and method for retrieving a multimedia message in a mobile communication terminal.

Another aspect of the present invention is to provide an apparatus and method for determining whether the subscriber identification module is altered, and determining whether to perform a retrieval procedure in a mobile communication terminal.

A further object of the present invention is to provide an apparatus and a method for preventing a user from retrieving a multimedia message when a subscriber identification module is altered in a mobile communication terminal.

According to an aspect of the present invention, there is provided a method of retrieving a multimedia message in a mobile communication terminal. The method includes checking whether a Subscriber Identification Module (SIM) installed in the mobile communication terminal is altered, when a retrieval event for a multimedia message occurs; and issuing a notification that receiving the multimedia message is not authorized, when the SIM is altered.

According to another aspect of the present invention, there is provided an apparatus for retrieving a multimedia message in a mobile communication system. The apparatus includes an SIM in which user data is recorded; an SIM comparing unit for determining whether the SIM is altered using the user data, and outputting a determined result, when a retrieval event for the multimedia message occurs; and a controller for determining whether to perform a retrieval of the multimedia message according to the determined result.

### BRIEF DESCRIPTION OF THE DRAWINGS

The above and other objects, features and advantages of the present invention will become more apparent from the following detailed description when taken in conjunction with the accompanying drawings in which:

FIG. 1 is a ladder-type diagram showing the process of receiving multimedia messages in a mobile communication terminal according to the conventional art;

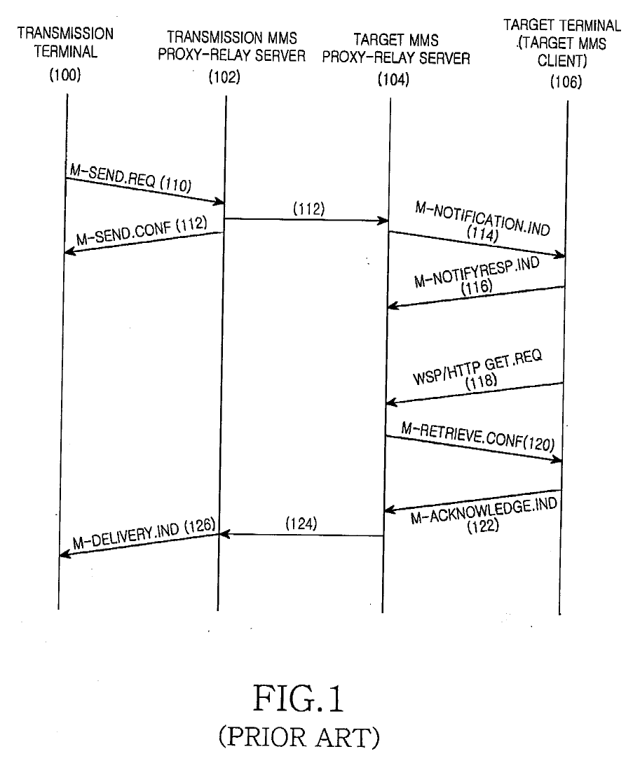

FIG. 2 is a block diagram showing a configuration of a mobile communication terminal according to the present invention; and

FIG. 3 is a flowchart showing a procedure for preventing the retrieval of multimedia message, when a subscriber identification module is altered in a mobile communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Described hereinafter are an apparatus and method for preventing the retrieving of a multimedia message when a subscriber identification module is altered in a mobile communication terminal. Here, the subscriber identification module denotes all modules including Subscriber Identification Modules (SIM) and Universal Subscriber Identification Modules (USIM) in which user data is recorded. Hereinafter, the SIM will be described according to the present invention.

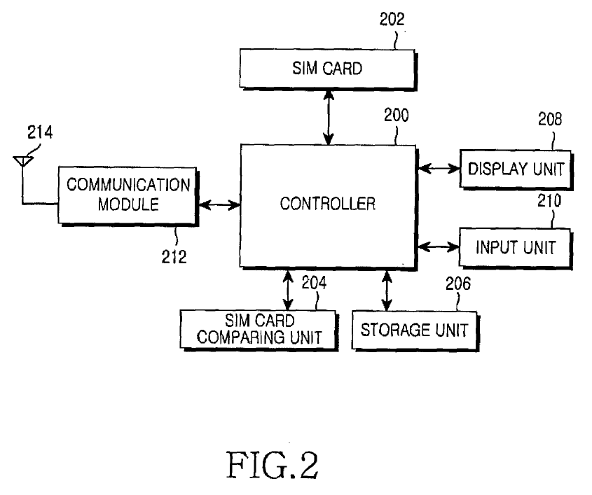

FIG. 2 is a block diagram showing the configuration of a mobile communication terminal according to the present invention. Here, the mobile communication terminal includes a controller 200, an SIM card 202, an SIM card comparing unit 204, a storage unit 206, a display unit 208, an input unit 210, a communication module 212, and an antenna 214.

Referring to FIG. 2, the controller 200 is for processing and controlling voice and data communication. When an MMS notification message is received, the controller 200 checks the telephone number recorded in the SIM card 202 and stores it into the storage unit 206. When an event for receiving the multimedia message occurs, the controller 200 reads the telephone number stored in the storage unit and checks the current telephone number of the SIM card 202 in the mobile communication terminal to transmit them to the SIM card comparing unit 204 for comparing whether the two telephone numbers correspond. Thereafter, the SIM card comparing unit 204 sends a comparing result to the controller 200. When the two telephone numbers correspond, the controller 200 performs the function for retrieving MMS, but when the two telephone numbers do not correspond, the controller 200 outputs a message notifying that there is a lack of authorization to receive the multimedia message to the display unit 208.

The SIM card 202, which is detachable from the mobile communication terminal, has a microprocessor and a memory chip for storing the subscriber data, and especially for performing the function of outputting the stored telephone number to the controller 200.

After receiving the current telephone number of the SIM card 202 and the telephone number stored in the storage unit 206 through the controller 200, the SIM card comparing unit 204 compares the two telephone numbers and sends the result of whether one telephone number corresponds with the other to the controller 200.

The storage unit 206 stores the telephone number sent from the controller 200 according to the present invention.

The display unit 208 displays a limited number of characters or status information caused by the operation of the mobile communication terminal. In particular, the display unit 208 displays a message notifying that a user does not have authority to receive the MMS message under control of the controller 200.

The input unit 210, having many function keys, sends data corresponding to the key inputted by the user to the controller 200.

The communication module 212 transmits and receives radio signals of data received and transmitted via an antenna 214. For example, when transmitting, the communication module 212 channel-codes and spreads data to be transmitted, converts baseband signals into Radio Frequency (RF) signals, and transmits the RF signal via the antenna. Alternatively, when receiving, the communication module 212 converts received RF signals into baseband signals, de-spreads and channel-decodes the baseband signals to recover corresponding data.

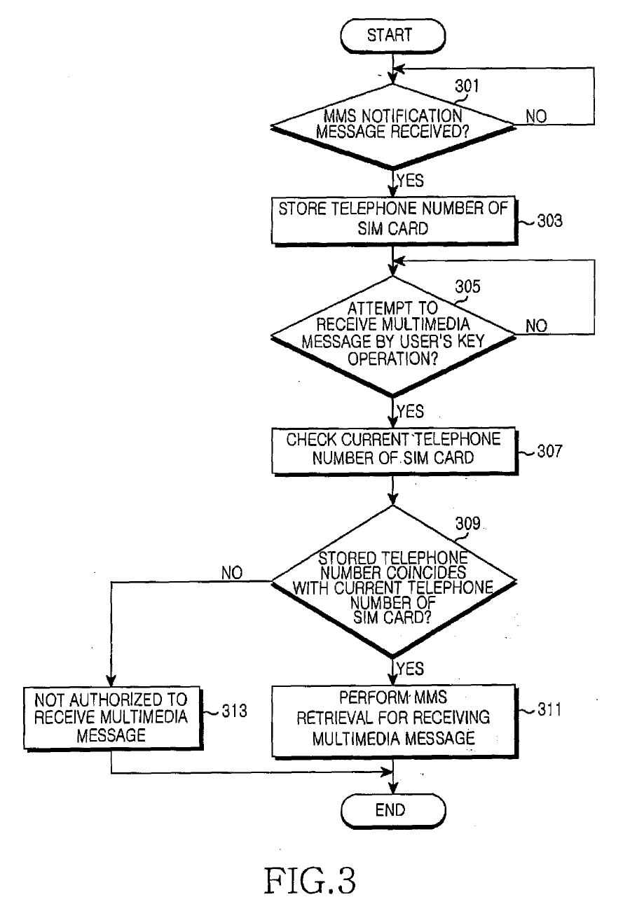

FIG. 3 is a flow chart showing a process for preventing the retrieval of a multimedia message when an SIM card is altered in a mobile communication terminal according to the present invention.

Referring to FIG. 3, the above mobile communication terminal checks whether the MMS notification message is received from the MMS proxy-relay server in step 301. When the MMS notification message is received, at the same moment, the mobile communication terminal checks a telephone number in the SIM card 202 attached to the mobile communication terminal, stores the telephone number to the storage unit 206, and displays a message asking whether to receive the multimedia message at the display unit 208 in step 303.

Thereafter, in step 305 the mobile communication terminal checks whether the event for receiving the multimedia message by a user's key operation occurs. At the moment when the event for receiving the multimedia message occurs, the mobile communication terminal checks the current telephone number in the SIM card 202 installed in the mobile communication terminal in step 307.

Then, in step 309 the mobile communication terminal checks whether the SIM card is altered by comparing the current telephone number in SIM card 202 with the telephone number stored in the storage unit 206. In other words, the mobile communication terminal checks whether the SIM card installed in the mobile communication terminal is altered from the time the MMS notification message is received to when the event for receiving the multimedia message occurs.

When the SIM card is not altered, the mobile communication terminal performs MMS retrieval to receive the multimedia message in step 311. When the SIM card 202 is altered, the mobile communication terminal notifies the user that the user does not have authority to receive the multimedia message and terminates the algorithm according to the present invention in step 313.

As described above, by determining whether to retrieve the multimedia message after checking if the SIM card is altered, the present: invention can prevent an unauthorized mobile communication terminal from connecting to the network unnecessarily and remove overhead caused by server authentication. Also, without connecting to the network, the present invention is able to provide a user with quick response by informing the user that the user is not authorized to receive the multimedia message.

In the above description, it is determined by using the telephone number in the SIM card whether the SIM card is altered. Also it can be determined by using other user data recorded in the SIM card.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of retrieving a multimedia message in a mobile communication terminal, the method comprising the steps of:
checking whether a Subscriber Identification Module (SIM) installed in the mobile communication terminal is altered, when a retrieval event for a multimedia message occurs; and
issuing a notification that receiving the multimedia message is not authorized, when the SIM is altered.

2. The method of claim 1, wherein checking whether the SIM is altered comprises comparing data of the SIM installed in the terminal at a point when a notification message for the multimedia message is received, and data of the SIM installed in the terminal at a point when the retrieval event occurs.

3. The method of claim 2, wherein the data is a telephone number.

4. The method of claim 1, further comprising performing a retrieval procedure for receiving the multimedia message from a server when the SIM is not altered.

5. The method of claim 1, wherein checking of whether the SIM is altered comprises:
reading the stored data of the terminal, when a retrieval event occurs;
acquiring the current data of the terminal from an SIM installed in the terminal; and
comparing the stored data with the current data to determine whether the SIM is altered.

6. An apparatus for retrieving a multimedia message in a mobile communication system, the apparatus comprising:
a Subscriber Identification Module (SIM) in which user data is recorded;
a SIM comparing unit for determining whether the SIM is altered using the user data, and outputting a determined result, when a retrieval event for the multimedia message occurs; and
a controller for determining whether to perform a retrieval of a multimedia message according to the outputted result.

7. The apparatus of claim 6, wherein determining whether the SIM is altered is performed by comparing data of an SIM installed in a terminal at a point when a notification message for the multimedia message is received and data of the SIM installed in the terminal at a point when the retrieval event occurs.

8. The apparatus of claim 7, wherein the data is a telephone number.

9. A method of retrieving a multimedia message in a mobile communication terminal, the method comprising the steps of:
checking whether a Subscriber Identification Module (SIM) installed in the mobile communication terminal is altered, when a retrieval event for a multimedia message occurs.

10. The method of claim 9, further comprising issuing a notification that receiving the multimedia message is not authorized, when the SIM is altered.

11. The method of claim 9, further comprising performing a retrieval procedure for receiving the multimedia message from a server when the SIM is not altered.

12. The method of claim 9, wherein checking whether the SIM is altered comprises comparing data of the SIM installed in the terminal at a point when a notification message for the multimedia message is received, and data of the SIM installed in the terminal at a point when the retrieval event occurs.

13. The method of claim 9, wherein checking of whether the SIM is altered comprises:
reading the stored data of the terminal, when a retrieval event occurs;
acquiring the current data of the terminal from an SIM installed in the terminal; and
comparing the stored data with the current data to determine whether the SIM is altered.

14. A mobile communication terminal for retrieving a multimedia message comprising:
means for checking whether a Subscriber Identification Module (SIM) installed in the mobile communication terminal is altered, when a retrieval event for a multimedia message occurs.

15. The mobile communication terminal of claim 14, further comprising means for issuing a notification that receiving the multimedia message is not authorized, when the SIM is altered.

16. The mobile communication terminal of claim 14, further comprising means for performing a retrieval procedure for receiving the multimedia message from a server when the SIM is not altered.

17. The mobile communication terminal of claim 14, wherein the means for checking whether the SIM is altered performs comparing data of the SIM installed in the terminal at a point when a notification message for the multimedia message is received, and data of the SIM installed in the terminal at a point when the retrieval event occurs.

18. The mobile communication terminal of claim 14, wherein the means for checking of whether the SIM is altered comprising:
means for reading the stored data of the terminal, when a retrieval event occurs;
means for acquiring the current data of the terminal from an SIM installed in the terminal; and
means for comparing the stored data with the current data to determine whether the SIM is altered.
